(19) United States
(12) Patent Application Publication
(10) Pub. No.: US 2026/0096002 A1
(43) Pub. Date: Apr. 2, 2026

(54) DIELECTRIC BARRIER DISCHARGE DEVICE CONFIGURATIONS

(71) Applicant: AEROJET ROCKETDYNE, INC., Melbourne, FL (US)

(72) Inventor: Justin Pucci, Kenmore, WA (US)

(21) Appl. No.: 18/901,402

(22) Filed: Sep. 30, 2024

(51) Int. Cl. H05H 1/24; H05H 1/54

(52) U.S. Cl. CPC H05H 1/2406; H05H 1/54

(57) ABSTRACT

A dielectric barrier discharge device includes a dielectric layer that has opposed first and second sides, a first electrode on the first side that defines a ring that circumscribes a cavity, a second electrode on the second side, a gas inlet connected with the cavity, and a power supply electrically connected with the electrodes. The dielectric layer has a surface exposed at a first end of the cavity.

### BACKGROUND

A dielectric barrier discharge (DBD) device includes two electrodes, one of which is covered in a dielectric barrier material. The electrodes are connected with an alternating current power source that drives electrical discharges in a gap between the electrodes. The discharges cause gas ionization every electrical half-cycle. The resulting plasma interacts with the surrounding air or other gaseous medium to induce a net flow, which is often referred to as an ionic wind or electrical wind. DBD devices are used as ozone generators, ultraviolet light lamps, plasma generators, and aerodynamic flow controllers, for example.

### SUMMARY

A dielectric barrier discharge device according to an example of the present disclosure includes a dielectric layer that has opposed first and second sides, a first electrode on the first side that defines a ring that circumscribes a cavity, a second electrode on the second side, a gas inlet connected with the cavity, and a power supply electrically connected with the electrodes. The dielectric layer has a surface exposed at a first end of the cavity.

A dielectric barrier discharge device according to another example of the present disclosure includes a dielectric layer having opposed first and second sides and a first electrode on the first side of the dielectric layer. The first electrode defines an array of cavities, and the dielectric layer has surfaces exposed at first ends of the cavities. A second electrode is disposed on the second side of the dielectric layer opposite the cavities, and there are gas inlets fluidly connected with the cavities. A power supply is electrically coupled with the first electrode and the second electrode.

The present disclosure may include any one or more of the individual features disclosed above and/or below alone or in any combination thereof.

### BRIEF DESCRIPTION OF THE DRAWINGS

The various features and advantages of the present disclosure will become apparent to those skilled in the art from the following detailed description. In this disclosure, like reference numerals designate like elements where appropriate and reference numerals with the addition of one-hundred or multiples thereof designate modified elements that are understood to incorporate the same features and benefits of the corresponding elements. The drawings that accompany the detailed description can be briefly described as follows.

FIG. 1 illustrates a dielectric barrier discharge device.

FIG. 2 illustrates a further example of a dielectric barrier discharge device that has a magnetic ring.

FIG. 3A illustrates a sectioned view of an arrayed dielectric barrier discharge device.

FIG. 3B illustrates a top view of the arrayed dielectric barrier discharge device.

FIG. 4A illustrates a sectioned view of another arrayed dielectric barrier discharge device.

FIG. 4B illustrates a top view of the arrayed dielectric barrier discharge device.

### DETAILED DESCRIPTION

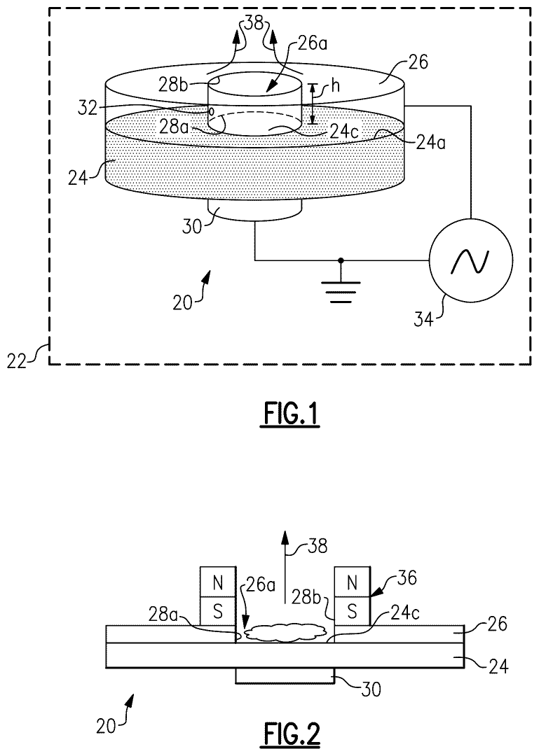

FIG. 1 illustrates a dielectric barrier discharge device 20. The device 20 in this example is used in a thruster 22. Later example devices are also used in a thruster. The devices are not limited to use as such an application and may alternatively be used in many other applications, including but not limited to, a synthetic jet actuator for boundary layer control, an ozone generator, an ultraviolet light lamp, and a plasma generator.

The device 20 includes a dielectric layer 24 that has opposed first and second sides 24a/24b. For example, the dielectric layer 24 is made of a solid dielectric material, which is an electrical insulator that polarizes on the application of electric field due to shifting and net displacement of positive and negative charges. Many ceramics, mica, and quartz glass are considered dielectric materials. Further example dielectric materials include, but are not limited to, aluminum nitride, boron nitride, alumina, and borosilicate.

There is a first electrode 26 on the first side 24a of the dielectric layer 24. The first electrode 26 is in the form of a ring that circumscribes a cavity 26a. In the illustrated example, the ring is circular and the cavity is cylindrical. For example, the cavity 26a has a diameter of at least 2 millimeters, such as 5 millimeters, but may be as large as 20 millimeters or more. An electrode 26 that has a cavity 26a that is smaller than 2 millimeters functions as a continuous plate and thus cannot produce the desired effect of generating a plasma, while substantially larger sizes may be power limited and thus impractical. Additionally, for compactness and electric field generation, the cavity 26a has height (h) and an aspect ratio of the diameter of the cavity 26a to the height is greater than one.

The cavity 26a extends through the thickness of the first electrode 26 such that the dielectric layer 24 has a surface 24c exposed at a first end 28a of the cavity 26a. There is a second electrode 30 on the second side 24b of the dielectric layer 24 opposite the cavity 26a. In some examples, the second electrode 30 is encased in the dielectric layer 24. There is a gas inlet 32 fluidly connected with the cavity 26a, for providing a working gas to the device 20, such as air, argon, or hydrazine. All of the devices herein are useful with a variety of different gases, which further enables multi-mode operation of the devices across various applications.

Power supply 34 is electrically coupled with the electrodes 26/30. For example, the power supply 34 is an alternating current source, though the power supply 34 may also include a direct current bias. The power supply 34, upon activation, generates a plasma in the cavity 26a from the working gas provided through the gas inlet 32. As represented by arrows 38, the plasma is expelled from a second, open end 28b of the cavity 26 opposite the first end 28a.

FIG. 2 illustrates a sectioned view of selected portions of a further example of the device 20 taken along a plane that includes the central axis of the cylindrical cavity 26a. In this example, the device 20 additionally includes a magnetic ring 36 on the first electrode 26. The magnetic ring 36 is positioned such that it aligns with and circumscribes the second end 28b of the cavity 26. In this example, the magnetic ring 36 is a permanent magnet, though it is to be understood that an electromagnet could alternatively be used. The magnetic ring 36 provides a magnetic field that serves to accelerate the plasma expelled from the second end 28b. The cylindrical cavity 26 and the magnetic ring 36 facilitate focusing the plasma discharge, thus increasing the potential for ionizing collisions, increasing plasma density, and increasing residence time in comparison to linear dielectric barrier discharge devices. The focusing of the plasma also increases thermal energy transfer and momentum transfer to the local neutral population, which can enhance performance as an aerodynamic actuator and ozone generator. For example, the electron velocity vector is in the azimuthal direction (Hall current), which will drive magnetic confinement of ionizing electrons and thus increase degree of ionization.

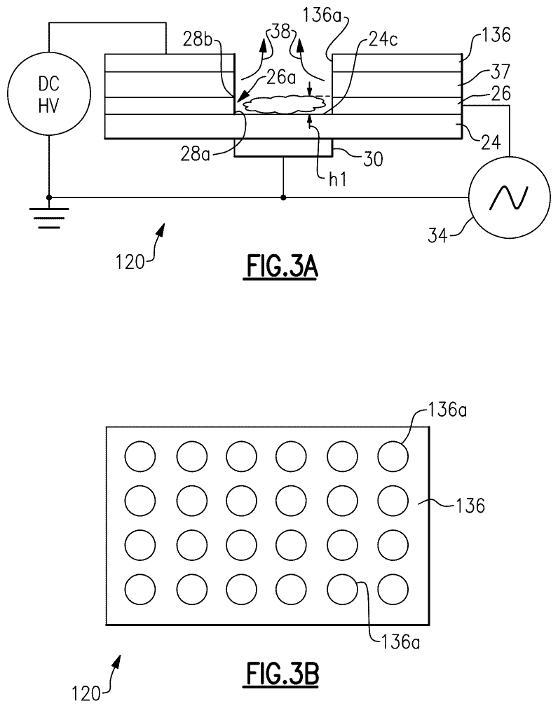

FIG. 3A illustrates a sectioned view through selected portions of another example dielectric barrier discharge device 120, and FIG. 3B illustrates a top view looking down into the device 120. Conceptually, the device 120 integrates multiple devices 20 into an array configuration with an electrostatic grid 136. The array configuration increases plasma generation and ionic wind flux, which can result in greater electric propulsion thrust production, ozone production, or airfoil boundary layer control influence.

For example, the first electrode 26 includes a plurality of cavities 26a that are provided in an array grid pattern of rows and columns, with the electrostatic grid 136 provided over the cavities 26a. There is an insulation layer 37 between the grid 136 and the first electrode 26 to maintain electric isolation. The electrostatic grid 136 includes an array of openings 136a that are superimposed over the outlet ends 28b. Like the magnet 36, the grid 136 serves to accelerate the plasma from the cavities 26a.

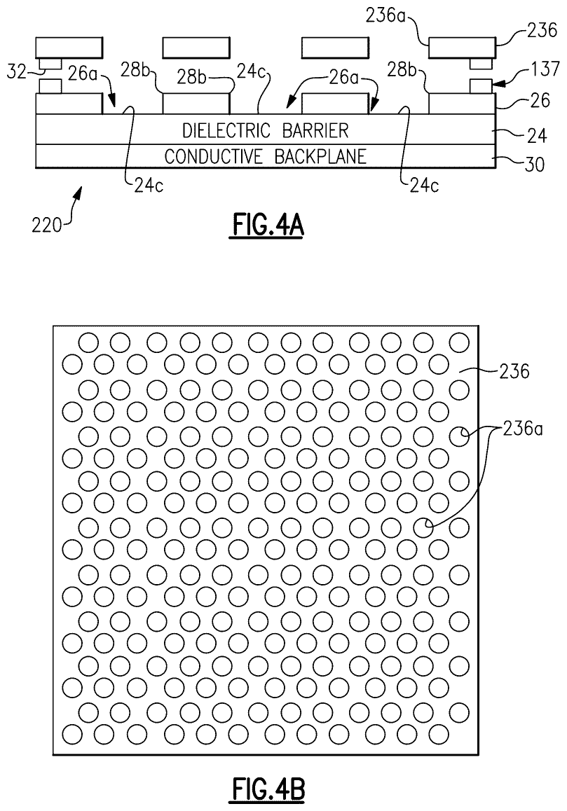

FIG. 4A illustrates a sectioned view through selected portions of another example dielectric barrier discharge device 220, and FIG. 4B illustrates a top view looking down into the device 220. Like the device 120, the device 220 integrates multiple devices 20 into an array configuration with an electrostatic grid 236. A DC bias may be provided for the electrostatic grid 236. For example, the first electrode 26 includes a plurality of cavities 26a that are provided in an arrangement of rows and columns, with the electrostatic grid 236 provided over the cavities 26a. There is an insulation layer 137 between the grid 236 and the first electrode 26 to maintain electric isolation. The electrostatic grid 236 includes an array of openings 236a that are superimposed over the outlet ends 28b. Like the magnet 36, the grid 236 serves to accelerate the plasma from the cavities 26a. Additionally in this example, there are one or more gas inlets 32 in the insulation layer 137, to feed propellant working gas through the device 220. In this example, the rows are offset, which provides a greater density of cavities 26a and openings 236a per unit area.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from this disclosure. The scope of legal protection given to this disclosure can only be determined by studying the following claims.

What is claimed is:

1. A dielectric barrier discharge device comprising:
a dielectric layer having opposed first and second sides;
a first electrode on the first side of the dielectric layer, the first electrode defining a ring that circumscribes a cavity, the dielectric layer having a surface exposed at a first end of the cavity;
a second electrode on the second side of the dielectric layer opposite the cavity;
a gas inlet fluidly connected with the cavity; and
a power supply electrically coupled with the first electrode and the second electrode.

2. The dielectric barrier discharge device as recited in claim 1, wherein the power supply, upon activation, generates a plasma from gas flowing into the cavity from the gas inlet and the plasma is expelled from a second, open end of the cavity opposite the first end.

3. The dielectric barrier discharge device as recited in claim 1, further comprising a magnetic ring on the first electrode and circumscribing the second end of the cavity, the magnetic ring accelerating the plasma expelled from the second end.

4. The dielectric barrier discharge device as recited in claim 3, further comprising an insulation layer between the magnetic ring and the first electrode.

5. The dielectric barrier discharge device as recited in claim 1, wherein the cavity is cylindrical and has a diameter of at least 2 millimeters.

6. The dielectric barrier discharge device as recited in claim 1, wherein the cavity has height and an aspect ratio of diameter to height is greater than one.

7. A dielectric barrier discharge device comprising:
a dielectric layer having opposed first and second sides;
a first electrode on the first side of the dielectric layer, the first electrode defining an array of cavities, the dielectric layer having surfaces exposed at first ends of the cavities;
a second electrode on the second side of the dielectric layer opposite the cavities;
gas inlets fluidly connected with the cavities; and
a power supply electrically coupled with the first electrode and the second electrode.

8. The dielectric barrier discharge device as recited in claim 7, wherein the power supply, upon activation, generates a plasma from gas flowing into the cavities from the gas inlets and the plasma is expelled from second, open ends of the cavities opposite the first ends.

9. The dielectric barrier discharge device as recited in claim 7, wherein the array has a grid pattern.

10. The dielectric barrier discharge device as recited in claim 7, wherein the gas inlets are in the insulation layer.

11. The dielectric barrier discharge device as recited in claim 7, wherein each of the cavities is cylindrical and has a diameter of at least 2 millimeters.

12. The dielectric barrier discharge device as recited in claim 7, wherein the dielectric barrier discharge device is in a thruster.
